(19) United States
(12) Patent Application Publication
(10) Pub. No.: US 2011/0164162 A1
(43) Pub. Date: Jul. 7, 2011

(54) SOLID-STATE IMAGING DEVICE AND METHOD FOR DRIVING THE SAME

(75) Inventor: Yoshiaki KATO, Shiga (JP)

(73) Assignee: PANASONIC CORPORATION, Osaka (JP)

(21) Appl. No.: 13/048,128

(22) Filed: Mar. 15, 2011

Related U.S. Application Data
(63) Continuation of application No. PCT/JP2009/001327, filed on Mar. 25, 2009.

(30) Foreign Application Priority Data
Sep. 25, 2008 (JP) 2008-245789

(51) Int. Cl. H04N 5/335

(52) U.S. Cl. 348/311; 348/E05.091

(57) ABSTRACT

A solid-state imaging device includes vertical transfer units each of which is configured to transfer charge read from light receiving units, a first horizontal transfer unit and a second horizontal transfer unit each of which includes a plurality of transfer gate electrodes arranged in parallel to one another, a sorting transfer unit configured to transfer charge between the horizontal transfer units, and an output unit. In the first horizontal transfer unit, the transfer gate electrodes extend from the vertical transfer units toward the sorting transfer unit, and at least a part of each of the plurality of transfer gate electrodes located closer to the vertical transfer units is obliquely extends so that a horizontal distance from the output unit increases as it extends toward the sorting transfer unit.

### CROSS-REFERENCE TO RELATED APPLICATION

This is a continuation of PCT International Application PCT/JP2009/001327 filed on Mar. 25, 2009, which claims priority to Japanese Patent Application No. 2008-245789 filed on Sep. 25, 2008. The disclosures of these applications including the specifications, the drawings, and the claims are hereby incorporated by reference in their entirety.

### BACKGROUND

The present disclosure relates to a solid-state imaging device such as a CCD image sensor etc., and a method for driving the solid-state imaging device, and more particularly to a configuration of a horizontal transfer unit of a solid-state imaging device and a method for driving the horizontal transfer unit.

In recent years, the resolution of solid imaging devices has been increased, and solid imaging devices having a resolution of more than ten million pixels have appeared, and a solid image having as good quality as that of a picture taken by a silver salt camera can be taken, or a moving picture having a good quality can be taken. With this increase in the resolution of solid imaging devices, the pixel unit size has been reduced, and the pixel pitch of solid imaging devices is smaller than 2 μm. This trend continues and the pixel unit size and the pixel pitch are being further reduced.

Moreover, even with the above-described digital still camera (DSC), a moving picture having as good quality as that of a moving picture taken in a movie mode of a conventional video camera can be taken, and the moving picture resolution of digital still cameras is improved every year.

FIG. 17 is a view schematically illustrating a layout of a conventional interline-transfer solid-state imaging device (ITCCD).

As shown in FIG. 17, the conventional solid-state imaging device includes photodiodes 102 arranged in a two-dimensional array on a semiconductor substrate (not shown), a vertical transfer unit 103 configured to transfer signal charge stored in the photodiodes 102 in a vertical direction, a first horizontal transfer unit 106 and a second horizontal transfer unit 108 each being configured to transfer the signal charge transferred by the vertical transfer unit 103 in a horizontal direction, a first output unit 105 configured to detect the signal charge transferred by the first horizontal transfer unit 106 to output the signal charge, a second output unit 109 configured to detect the signal charge transferred by the second horizontal transfer unit 108 to output the signal charge, and a sorting transfer gate unit 107 configured to sort a part of the signal charge transferred by the first horizontal transfer unit 106 and transfer the sorted part to the second horizontal transfer unit 108. The first horizontal transfer unit 106 includes a plurality of transfer gate electrodes 111 arranged in parallel to one another on the semiconductor substrate. Similarly, the second horizontal transfer unit 108 includes a plurality of transfer gate electrodes 113 arranged in parallel to one another on the semiconductor substrate.

For example, signal charge transferred from pixels in odd rows is transferred by the first horizontal transfer unit 106 in the horizontal direction, and is sequentially output from the first output unit 105 to the outside. Signal charge transferred from pixels in even rows is transferred from the first horizontal transfer unit 106 to the second horizontal transfer unit 108 via the sorting transfer gate unit 107, and is sequentially output from the second output unit 109. As described above, since the two horizontal transfer units are provided, the frequency of horizontal transfer pulses generated when a signal is transferred to the output unit can be reduced to half, as compared to when only one horizontal transfer unit is provided. Therefore, even with an increased number of pixels, the solid-state imaging device can be driven without greatly increasing the frequency of the horizontal-transfer pulse.

In the solid-state imaging device, when sorting transfer is performed, the generation of fixed pattern noise (FPN) has to be reduced. However, in a conventional solid-state imaging device described in Japanese Patent Publication No. H5-198602, a potential barriers (not shown) provided in a part of the first horizontal transfer unit 106 facing the sorting transfer gate unit 107 is in a saw tooth shape, when viewed from the top. With the above-described configuration, all members provided in the first horizontal transfer unit 106 serve as a strong transfer electric field unit. Thus, the efficiency of transfer of signal charge from the first horizontal transfer unit 106 to the second horizontal transfer unit 108 can be improved.

In the solid-state imaging device described in Japanese Patent No. 3136596, an impurity doped region is formed in a part of the semiconductor substrate located under the first horizontal transfer unit 106 so that the width of the impurity doped region gradually increases as it extends closer to the sorting transfer gate unit 107, thereby creating a potential gradient where the potential thereof reduces as it extends toward from the first horizontal transfer unit 106 to the sorting transfer gate unit 107. With this configuration, the efficiency of transfer of signal charge from the first horizontal transfer unit 106 to the second horizontal transfer unit 108 can be also improved.

### SUMMARY

However, in the above-described configuration, it has been difficult to reduce the generation of fixed pattern noise which is caused during sorting transfer, i.e., sorting FPN, and ensure a horizontal transfer capacity of the first horizontal transfer unit 106, or maintain horizontal transfer efficiency at the same time.

In the solid-state imaging device described in Japanese Patent No. 3136596, the potential depth in storage regions in the first horizontal transfer unit 106 increases as they extend closer to the sorting transfer gate unit 107, and a potential gap between each of the storage regions and an adjacent barrier region thereto increases. Accordingly, at a part where the potential gap is the largest, a sufficient potential change relative to an applied horizontal transfer pulse cannot be achieved. Thus, the efficiency of transfer in the horizontal direction is reduced, and a signal leaks in the horizontal direction, so that degradation of image quality such as reduction of resolution, etc., occurs.

In the solid-state imaging device described in Japanese Patent Publication No. H5-198602, although a potential gradient according to an impurity distribution is not created, the transfer width in the horizontal direction increases as it extends closer to the gate, and therefore, in the view that transfer in the horizontal direction is difficult, the solid-state imaging device of Japanese Patent Publication No. H5-198602 has similar problems to those of the solid-state imaging device of Japanese Patent No. 3136596.

A solid-state imaging device according to one example embodiment of the present disclosure and a method for driving the solid-state imaging device may reduce the generation of sorting FPN during transfer of charge from a horizontal transfer unit located closer to a pixel region to a horizontal transfer unit located farther from the pixel region, and also reduce reduction in the efficiency of transfer of charge in the horizontal direction.

A solid-state imaging device according to one example embodiment of the present disclosure includes a plurality of light receiving units arranged in a two-dimensional array, a plurality of vertical transfer units each of which is configured to transfer charge read from an associated one of the plurality of the light receiving units in a vertical direction, a plurality of horizontal transfer units each of which is configured to transfer the charge transferred by the vertical transfer units in a horizontal direction and includes a plurality of transfer gate electrodes arranged in parallel to one another on a substrate, the plurality of horizontal transfer units being arranged in the vertical direction, a sorting transfer unit which includes at least one shift gate electrode being provided on the substrate and extending in the horizontal direction, is provided between the plurality of the horizontal transfer units, and is configured to transfer charge between the plurality of the horizontal transfer units, and an output unit configured to detect the charge transferred by the plurality of horizontal transfer units, in a first horizontal transfer unit which is one of the plurality of the horizontal transfer units other than one of the horizontal transfer units located farthest from the vertical transfer units, the plurality of transfer gate electrodes extend from a side of the first horizontal transfer unit located closer to the vertical transfer units toward the sorting transfer unit located adjacent to the first horizontal transfer unit in the vertical direction, and at least a part of each of the plurality of transfer gate electrodes located closer to the vertical transfer units obliquely extends so that a horizontal distance from the output unit increases as it extends toward the sorting transfer unit located adjacent to the first horizontal transfer unit in the vertical direction.

In this configuration, in the first horizontal transfer unit, a predetermined driving voltage is applied to the plurality of transfer electrodes, and thus, charge can be transferred in the horizontal direction and also transferred in the vertical direction at the same time. Therefore, the efficiency of sorting transfer can be improved by transferring charge to a part near the sorting transfer unit before and after sorting transfer. Also, under the transfer gate electrodes of the first horizontal transfer unit, the potential of regions for storing charge does not have to be as deep as that required in a conventional solid-state imaging device, reduction in efficiency of transfer of charge in the horizontal direction can be prevented or reduced.

Note that it is preferable that the first horizontal transfer unit is one of the plurality of horizontal transfer units located closest to the vertical transfer unit, because charge transferred by the vertical transfer unit can be transferred to another one of the horizontal transfer units located adjacent to the first horizontal transfer unit in the vertical direction with high efficiency.

In the first horizontal transfer unit, when potential packet regions are respectively formed immediately under parts of the plurality of transfer gate electrodes facing the sorting transfer unit, and each of the potential packet regions has a lower potential than potentials of regions located immediately under other parts of the transfer gate electrodes, charge can be stored in the potential packet regions. Thus, the efficiency of sorting transfer can be improved, and the generation of fixed pattern noise which is caused by sorting transfer can be reduced.

In the first horizontal transfer unit, each of the plurality of transfer gate electrodes may include a bent portion which is bent so that an end portion of the transfer gate electrode located closer to the sorting transfer unit located adjacent to the first horizontal transfer unit in the vertical direction extends in the vertical direction.

According to one example embodiment of the present disclosure, a method for driving a solid-state imaging device, the solid-state imaging device including a plurality of light receiving units arranged in a two-dimensional array, a plurality of vertical transfer units, a plurality of horizontal transfer units each of which includes a plurality of transfer gate electrodes arranged in parallel to one another on a substrate, the plurality of horizontal transfer units being arranged in the vertical direction, a sorting transfer unit which includes at least one shift gate electrode being provided on the substrate and extending in the horizontal direction, and is provided between the plurality of the horizontal transfer units, and an output unit provided for each of the plurality of the horizontal transfer units, the solid-state imaging device being configured so that in a first horizontal transfer unit which is one of the plurality of the horizontal transfer units located closest to the vertical transfer unit, the plurality of transfer gate electrodes extend from the vertical transfer units toward the sorting transfer unit located adjacent to the first horizontal transfer unit, and at least a part of each of the plurality of transfer gate electrodes located closer to the vertical transfer units obliquely extends so that a horizontal distance from the output unit increases as it extends toward the sorting transfer unit, includes the steps of: (a) transferring the charge read from the plurality of light receiving units in the vertical direction toward the first horizontal transfer unit by the vertical transfer units, (b) moving the charge transferred in the step (a) in the horizontal direction and moving the charge in the vertical direction; (c) applying a control voltage to the at least one shift gate electrode to sort a part of the charge transferred in the step (a) and transferring the sorted part from the first horizontal transfer unit to a second transfer unit which is one of the plurality of horizontal transfer units located adjacent to the first horizontal transfer unit via the sorting transfer unit; and (d) transferring, after the steps (b) and (c), charge in the first horizontal transfer unit and the second horizontal transfer unit in the horizontal direction toward the output unit.

According to this method, charge read from the receiving units can be moved to a part near the sorting transfer unit in the step (b), and thus, the efficiency of transfer of charge during sorting transfer can be improved. Note that sorting transfer and pre-sorting transfer may be appropriately combined in any order.

Note that the step (b) can be performed by applying control voltages having a plurality different phases to the plurality transfer electrodes in the first horizontal transfer unit. When the horizontal transfer unit is driven using control voltages having three or more phases, charge can be transferred in a reverse direction to the horizontal direction. Thus, when charge is moved too close to the output unit in the step (b), charge can be transferred in the reverse direction to prevent or reduce problems.

Note that a driving method according to one example embodiment may be executed by a control circuit in the solid-state imaging device, and a computer controlled by a program in which the above-described driving methods are described, etc. Also, a program configured to execute the above-described driving methods may be stored in a memory provided in an imaging device such as camera, etc., and also may be stored in a removable recording medium such as a CD-ROM, and a memory card, etc. A program configured to execute the above-described driving methods can be provided via a transmission medium such as Internet, etc.

A solid-state imaging device according to one example embodiment of the present disclosure and a method for driving the solid-state imaging device can achieve, during sorting transfer, highly efficient transfer of charge in the horizontal transfer unit located closer to the vertical transfer unit to the sorting transfer unit to reduce the generation of sorting FPN, and prevent or reduce reduction in efficiency of transfer of charge to the output unit. Therefore, even when a plurality of horizontal transfer units are provided as the number of pixels and the signal transfer speed are increased, reduction in image quality can be reduced.

### BRIEF DESCRIPTION OF THE DRAWINGS

FIG. 1 is a view schematically illustrating a planar configuration of a solid-state imaging device according to a first embodiment of the present disclosure.

FIG. 2 is a view schematically illustrating a planar configuration of a solid-state imaging device according to a second embodiment of the present disclosure.

FIG. 3 is a view schematically illustrating a planar configuration of a specific example of the solid-state imaging device of the second embodiment.

FIG. 4A is a plan view schematically illustrating a configuration of horizontal transfer units when a single shift gate electrode SG is provided in a sorting transfer unit.

FIG. 4B is a plan view schematically illustrating a configuration of horizontal transfer units when a first shift gate electrode SG1 and a second shift gate electrode SG2 are provided in a sorting transfer unit.

FIGS. 5A and 5B are timing diagrams showing a sorting transfer method and a horizontal transfer method in a solid-state imaging device in which only a single shift gate electrode is provided in a sorting transfer unit and a solid-state imaging device in which two shift gate electrodes are provided in a sorting transfer unit, respectively.

FIG. 6 is a diagram showing pre-sorting transfer operation and sorting transfer operation when only a shift gate electrode SG is provided in a sorting transfer unit 7.

FIG. 7 is a diagram showing pre-sorting transfer operation and sorting transfer operation when a first shift gate electrode SG1 and a second shift gate electrode SG2 are provided in the sorting transfer unit 7.

FIG. 8 is a timing diagram showing a second method for driving the solid-state imaging device according to the second embodiment.

FIG. 9 is a timing diagram showing an example of a method for driving the solid-state imaging device according to a third embodiment.

FIG. 10 is a diagram schematically showing how signal charge is moved during pre-sorting transfer in the method for driving the solid-state imaging device according to the third embodiment.

FIG. 11 is a timing diagram showing the method for driving the solid-state imaging device according to the third embodiment when horizontal reverse transfer is performed.

FIG. 12 is a diagram schematically showing how signal charge is moved during horizontal reverse transfer in the driving method of FIG. 11.

FIG. 13 is a timing diagram showing a variation of the method for driving the solid-state imaging device according to the third embodiment.

FIG. 14 is a view schematically illustrating a planar configuration of a solid-state imaging device according to a fourth embodiment of the present disclosure.

FIG. 15 is a view schematically illustrating a planar configuration of a solid-state imaging device according to a fifth embodiment of the present disclosure.

FIG. 16 is a view schematically illustrating a planar configuration of a solid-state imaging device according to a sixth embodiment of the present disclosure.

FIG. 17 is a view schematically illustrating a layout of a conventional interline transfer solid-state imaging device (ITCCD).

### DETAILED DESCRIPTION

Embodiments of the present disclosure will be described in detail with reference to the accompanying drawings.

### FIRST EMBODIMENT

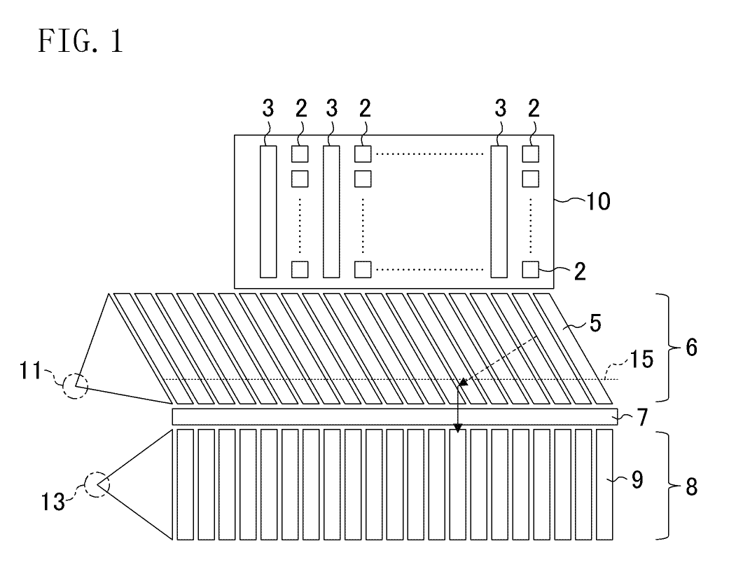

FIG. 1 is a view schematically illustrating a planar configuration of a solid-state imaging device according to a first embodiment of the present disclosure.

As shown in FIG. 1, the solid-state imaging device of this embodiment includes photo diodes (light receiving units) 2 arranged in a two-dimensional array on a pixel region 10 of a semiconductor substrate (not shown), vertical transfer units 3 located on the pixel region 10 and configured to transfer signal charge stored in the photo diodes 2, a first horizontal transfer unit 6 and a second horizontal transfer unit 8 each of which is configured to transfer signal charge transferred by the vertical transfer units 3 in the horizontal direction, a first output unit 11 configured to detect signal charge transferred by the first horizontal transfer unit 6 to output the detected signal charge, a second output unit 13 configured to detect signal charge transferred by the second horizontal transfer unit 8 to output the detected signal charge, and a sorting transfer unit 7 configured to sort a part of the signal charge transferred by the first horizontal transfer unit 6 to transfer the sorted signal charge to the second horizontal transfer unit 8. In this case, the vertical transfer units 3, the first horizontal transfer unit 6, and the second horizontal transfer unit 8 are respectively configured of CCDs. The first horizontal transfer unit 6 and the second horizontal transfer unit 8 are arranged in the vertical direction. The first horizontal transfer unit 6 includes a plurality of first transfer gate electrodes 5 arranged in parallel with one another on the semiconductor substrate. Similarly, the second horizontal transfer unit 8 includes a plurality of second transfer gate electrodes 9 arranged in parallel with one another on the semiconductor substrate. Although FIG. 1 shows only a simplified view of the solid-state imaging device, the first transfer gate electrodes 5 and the second transfer gate electrodes 9 are provided to correspond respectively to the vertical transfer units 3.

The sorting transfer unit 7 includes at least one shift gate electrode extending in the horizontal direction (a first direction) on the semiconductor substrate. The horizontal direction herein means a direction which is perpendicular to the vertical direction, when viewed in a plan view, and extends toward the output. The first output unit 11 and the second output unit 13 are respectively comprised of floating diffusion (FD) amplifiers. Note that only a single output unit may be provided for a plurality of horizontal transfer units. A distance between the shift gate electrode (or one of the shift gate electrodes located closest to the first transfer gate electrodes 5, when two or more shift gate electrodes are provided) and the first transfer gate electrodes 5 is, for example, about 10 nm or more and about 200 nm or less. Each of a space between adjacent two of the first transfer gate electrodes 5 and a space between adjacent two of the second transfer gate electrodes 9 is about 10 nm or more and about 200 nm or less.

Although not shown in FIG. 1, a storage region where signal charge is stored and a barrier region whose potential is higher than that of the storage regions are provided under each of the first transfer gate electrodes 5 and the second transfer gate electrodes 9. For example, in a region of the semiconductor substrate located immediately under each of the first transfer gate electrodes 5 and the second transfer gate electrodes 9, a barrier region is provided in a part located farther from an associated one of the first output unit 11 and the second output unit 13 to keep the signal charge transferred during horizontal transfer from being reversely moved. A barrier region is also provided between adjacent ones of potential packet regions provided in respective columns, so that the stored charge is kept from moving from the potential regions.

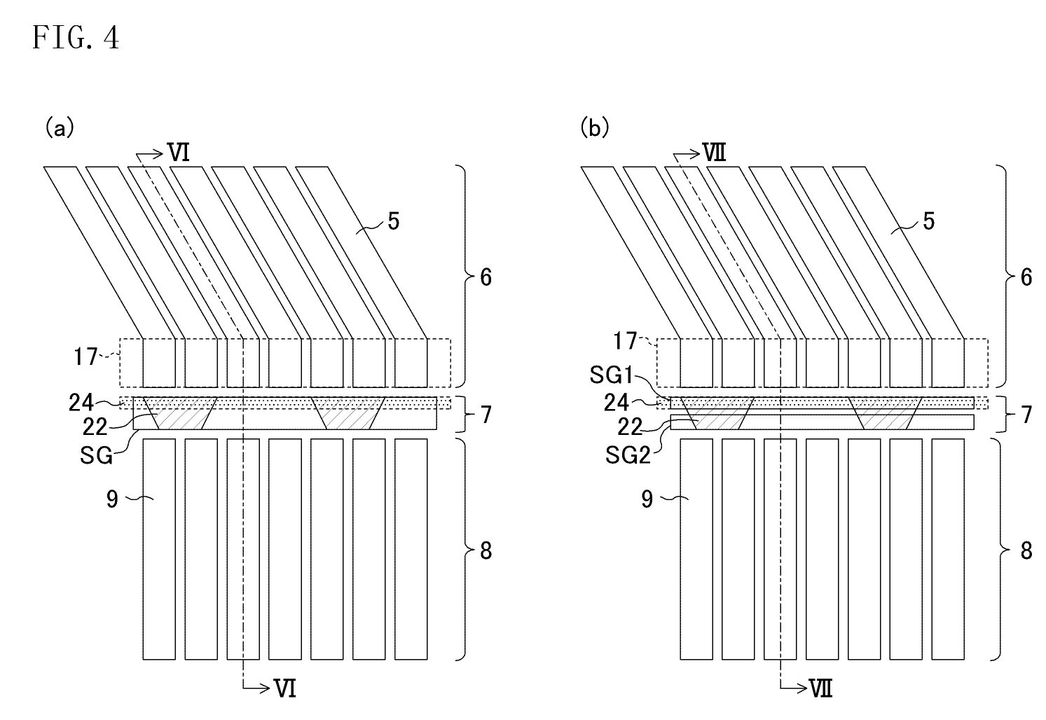

A potential of a region (specifically, e.g., a potential packet region 17 of FIGS. 4A and 4B) immediately under a part of each of the first transfer gate electrodes 5 facing the sorting transfer unit 7 (located closer to the sorting transfer unit 7) is deeper than a potential of a region immediately under another part of the first transfer gate electrode 5 (located closer to an associated one of the vertical transfer units 3). FIG. 1 shows an example location where an internal potential step 15 serving as a boundary of the potential packet region at a side closer to the vertical transfer units 3 (a pixel region) is created.

With the above-described configuration, signal charge which has been read from the vertical transfer units 3 (the pixel region 10) to the first horizontal transfer unit 6 tends to concentrate in parts of the semiconductor substrate located closer to the shift gate electrode, and thus, the efficiency of transfer of signal charge from the first horizontal transfer unit 6 to the second horizontal transfer unit 8 is improved. For example, when an n-type layer is formed immediately under the first transfer gate electrodes 5 and the gate insulating film, the potential packet regions are formed by increasing the concentration of an n-type impurity. Alternatively, the width of an associated one of the barrier regions formed in a part of the semiconductor substrate located under each of the first transfer gate electrodes 5 can be reduced at a region near the sorting transfer unit 7 to increase the width of the storage region, thereby obtaining a deep potential. Also, in this embodiment, a deep potential is created only in a region near the sorting transfer unit 7, and thus, as compared to the imaging device of Japanese Patent No. 3136596, reduction in the efficiency of transfer of signal charge in the horizontal direction in the first horizontal transfer unit 6 can be reduced.

In the solid-state imaging device according to one example embodiment of the present disclosure, in the first horizontal transfer unit 6, each of the first transfer gate electrodes 5 extends from an associated one of the vertical transfer units 3 toward the sorting transfer unit 7 located adjacent to the first horizontal transfer unit 6, and at least a part of each of the first transfer gate electrodes 5 obliquely extends in a direction in which a horizontal distance from the first output unit 11 increases as it extends toward the sorting transfer unit 7. Specifically, in the solid-state imaging device of this embodiment, an entire part of each of the first transfer gate electrodes 5 obliquely extends in a direction in which the horizontal distance from the first output unit 11 increases as it extends toward the sorting transfer unit 7. In contrast, each of the second transfer gate electrodes 9 extends in a direction substantially perpendicular to the shift gate electrode (in the vertical direction) when viewed from the top.

When a drive pulse is applied to the first transfer gate electrode 5, an electric field is generated in a direction perpendicular to the first transfer gate electrode 5, when viewed from the top. Therefore, with the above-described configuration, when signal charge is transferred in the horizontal direction in the first horizontal transfer unit 6, the signal charge can be moved to a part near the sorting transfer unit 7. Thus, signal charge can be transferred to parts of the semiconductor substrate located under the second transfer gate electrodes 9 without leaving remaining charge by performing sorting transfer of signal charge from the first horizontal transfer unit 6 to the second horizontal transfer unit 8 after pre-sorting transfer for collecting signal charge in parts of the regions of the semiconductor substrate immediately under each of the first transfer gate electrodes 5, which are located closer to the sorting transfer unit 7. As described above, in the solid-state imaging device of this embodiment, the first transfer gate electrodes 5 are arranged to extend obliquely relative to the vertical direction, and thus, signal charge can be effectively collected in the potential packet regions provided near the sorting transfer unit 7 without providing a potential gradient in the parts of the semiconductor substrate immediately under the first transfer gate electrodes 5. Therefore, even when the potential of the potential packet regions is shallow, as compared to the solid-state imaging device of Japanese Patent No. 3136596, signal charge can be transferred from the first horizontal transfer unit 6 to the second horizontal transfer unit 8 with high efficiency. Accordingly, an internal potential step between the barrier region (not shown) provided between adjacent ones of the potential packet regions and an associated one of the potential packet regions is not increased more than necessary, so that the efficiency of transfer of signal charge in the horizontal direction is not reduced. Based on the foregoing, in the solid-state imaging device of this embodiment, even when a plurality of horizontal transfer units are provided, the generation of sorting FPN can be reduced, and thus, reduction in the sorting FPN and increase in the number of pixels and the signal transfer speed can be achieved together. Moreover, even when the number of pixels is increased, degradation of image quality can be reduced.

In the solid-state imaging device of this embodiment, regions with a deep potential do not have to be formed respectively in the parts of the semiconductor substrate located immediately under the first transfer gate electrodes 5. However, it is preferable to provide such potential packet regions, because spread of signal charge transferred to a part near the shift gate electrode can be prevented or reduced, even when a slight time shift is caused between pre-sorting transfer and sorting transfer.

Horizontal transfer of signal charge in the first horizontal transfer unit 6 and the second horizontal transfer unit 8 may be performed by a three or four phase driving method as well as by a two phase driving method. A driving method will be described in the following embodiment.

In this embodiment, an example in which two horizontal transfer units are provided has been described. However, three or more horizontal transfer units may be provided so that a sorting transfer unit is interposed between adjacent ones of the horizontal transfer units. In such a case, in at least one of the horizontal transfer units other than one thereof located farthest from the vertical transfer units 3, transfer gate electrodes may be provided obliquely relative to the vertical direction. More preferably, at least in one of the horizontal transfer units located closest to the pixel region 10 (or the vertical transfer units 3), transfer gate electrodes are provided obliquely relative to the vertical direction.

Applications of the configuration according to the present disclosure are not limited to inter-line type solid-state imaging devices, but the configuration can be applied to frame transfer type solid-state imaging devices, and frame inter-line transfer type solid-state imaging devices, etc.

### SECOND EMBODIMENT

FIG. 2 is a view schematically illustrating a planar configuration of a solid-state imaging device according to a second embodiment of the present disclosure. In FIG. 2, each member also shown in FIG. 1 is identified by the same reference numeral, and the description thereof will be omitted or simplified.

As shown in FIG. 2, the solid-state imaging device of this embodiment is configured so that an end portion of each of the first transfer gate electrodes 5 located closer to the sorting transfer unit 7 is bent in a direction substantially perpendicular to the shift gate electrode (or in the vertical direction) in the solid-state imaging device of the first embodiment in which the first transfer gate electrodes 5 are arranged obliquely relative to the vertical direction.

With the above-described configuration, the direction of charge transfer during sorting transfer is perpendicular to the shift gate electrode, when viewed from the top, and thus, signal charge can be transferred with a smallest transfer distance during sorting transfer. Also, the width of the first transfer gate electrodes 5 can be increased relative to the direction of charge during sorting transfer, as compared to the solid-state imaging device of the first embodiment. Thus, due to an inverse narrow channel effect, the potential of the parts of the regions of the semiconductor substrate immediately under the first transfer gate electrodes 5, which are located closer to the shift gate electrode, becomes deep, so that the transfer efficiency during sorting transfer can be further improved.

In the solid-state imaging device of this embodiment, the internal potential step 15 is preferably formed around a bending point of each of the first transfer gate electrodes 5, when viewed in a plan view, because charge can be reliably transferred to the potential packet regions by pre-sorting transfer. In the region of the semiconductor substrate under a part of each of the first transfer gate electrodes 5 which is perpendicular to the shift gate electrode, charge does not move in a direction toward the shift gate electrode during horizontal transfer. Thus, when the internal potential step 15 is at a great distance from the bending point of the first transfer gate electrode 5 toward the shift gate electrode, charge which has moved closer to the sorting transfer unit 7 by pre-sorting transfer cannot reach the potential packet regions. Therefore, depending on process conditions, the internal potential step 15 is preferably located in a part at a distance of 1 μm or less from the bending point (a bent portion) of the first transfer gate electrode 5 toward the sorting transfer unit 7, when viewed from the top. In other words, the potential packet regions are preferably formed so that each of the potential packet regions includes at least a part of the semiconductor substrate located under the end portion of an associated one of the first transfer gate electrodes 5 located closer to the sorting transfer unit 7, and is located at a distance of 1 μm or less from the bending point of the first transfer gate electrode 5.

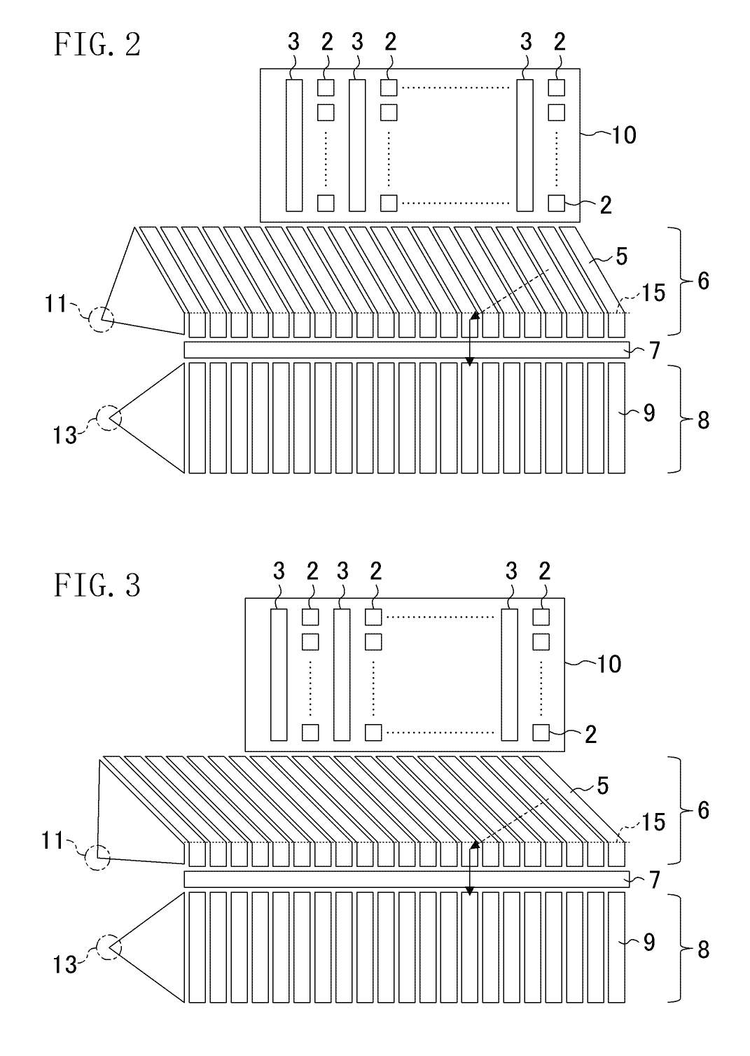

An angle which the part of each of the first transfer gate electrodes 5 obliquely extending toward the sorting transfer unit 7 makes with the vertical direction, when viewed in a plan view, is not particularly limited, but the obliquely extending part of the first transfer gate electrode 5 may be provided to make an acute angle with the vertical direction, when viewed in a plan view. Specifically, as in a specific example of the solid-state imaging device of this embodiment shown in FIG. 3, the angle is preferably about 45 degrees. To increase the effect of transfer of charge to a part near the shift gate electrode, the angle between each of the first transfer gate electrodes 5 and the shift gate electrode may be set to be smaller. However, considering transfer in the horizontal direction toward the output unit, it is the most preferable that a part of each of the first transfer gate electrodes 5 located closer to the pixel region 10 is oblique at an angle of about 45 degrees. Note that in this case, an angle at which the bent portion of the first transfer gate electrode 5 is bent is 135 degrees.

Similar to the solid-state imaging device of the first embodiment, in the solid-state imaging device of this embodiment, the sorting transfer unit 7 includes one or more shift gate electrodes provided on the semiconductor substrate with a gate insulating film interposed therebetween.

FIG. 4A is a plan view schematically illustrating a configuration of horizontal transfer units when a single shift gate electrode SG is provided in the sorting transfer unit 7. FIG. 4B is a plan view schematically illustrating a configuration of horizontal transfer units when a first shift gate electrode SG1 and a second shift gate electrode SG2 are provided in the sorting transfer unit 7.

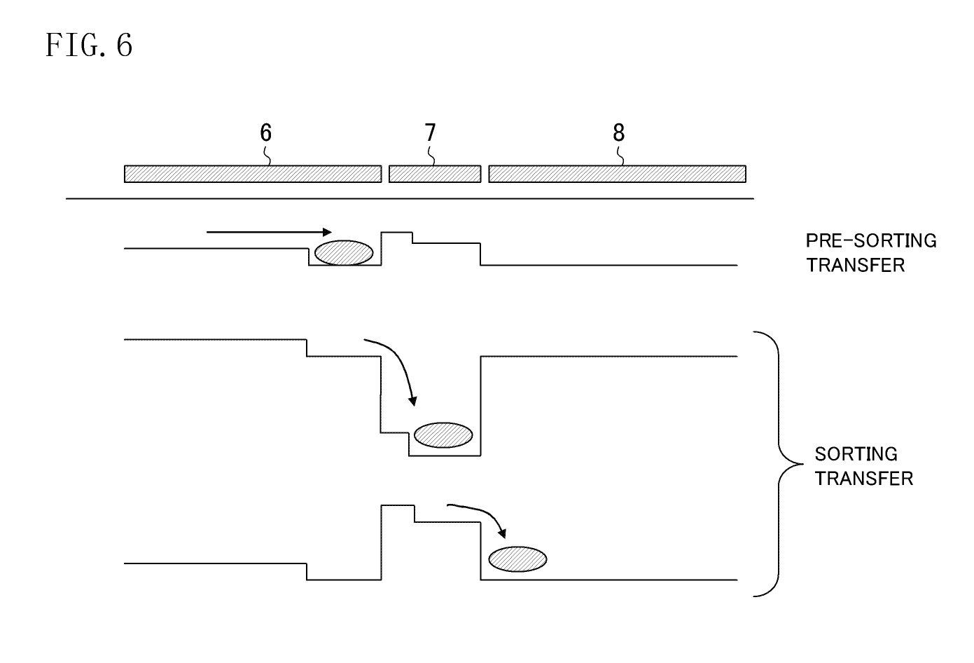

As shown in FIG. 4A, when only the shift gate electrode SG is provided in the counter circuit 7, an internal potential barrier 24 is formed under a part of the shift gate electrode SG located closer to the first horizontal transfer unit 6 and have a strip shape whose longitudinal direction is along the horizontal direction. For example, the internal potential barrier 24 can be formed by introducing a p-type impurity into an upper part of a predetermined region of the semiconductor substrate. The internal potential barrier 24 substantially prevents charge collected in potential packet regions 17 during pre-sorting transfer, which will be described later, from leaking to a side of the sorting transfer unit 7 (see FIG. 6). In a part of the semiconductor substrate located immediately under the shift gate electrode SG, barrier regions 22 are formed at predetermined intervals so that the width of each of the barrier regions 22 decreases as it extends in a direction from the first horizontal transfer unit 6 to the second horizontal transfer unit 8. The potential of the barrier regions 22 is high, as compared to other regions located under the shift gate electrode SG, and the efficiency of transfer of signal charge under the shift gate electrode SG is high. Also, the transfer path of the signal charge becomes wider at a side of the second horizontal transfer unit 8 during sorting transfer, thus improving the efficiency of transfer of the signal charge to the second horizontal transfer unit 8.

As shown in FIG. 4B, when the first shift gate electrode SG1 and the second shift gate electrode SG2 are provided in the sorting transfer unit 7, the internal potential barrier 24 may be provided only under the first shift gate electrode SG1 so that the potential of the internal potential barrier 24 can be separately controlled from the potential of a part located under the second shift gate electrode SG2.

—First Method for Driving Solid-State Imaging Device—

Next, an example of a first method for driving the solid-state imaging device according to this embodiment will be specifically described.

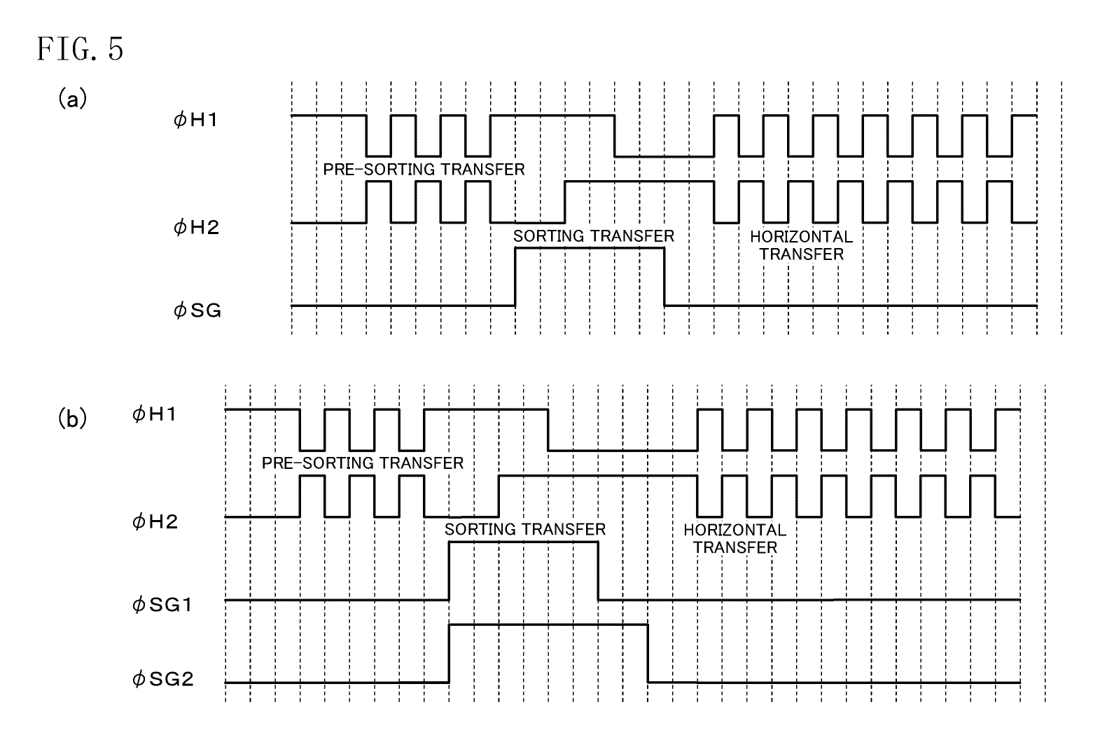

FIGS. 5A and 5B are timing diagrams showing a sorting transfer method and a horizontal transfer method in the solid-state imaging device, when only a single shift gate electrode is provided in a sorting transfer unit (FIG. 4A) and when two shift gate electrodes are provided in a sorting transfer unit (FIG. 4B), respectively. FIGS. 5A and 5B shows examples in which horizontal transfer is performed by a two phase driving method, and in the examples, transfer gate electrodes to which ΦH1 is applied and transfer gate electrodes to which ΦH2 is applied are alternately arranged. For example, a control voltage ΦH1 is applied to odd-numbered ones of the first transfer gate electrodes 5 and the second transfer gate electrodes 9, and a control voltage ΦH2 is applied to even-numbered ones of the first transfer gate electrodes 5 and the second transfer gate electrodes 9.

First, signal charge output from ones of the photo diodes 2 located in a single row, which has been transferred to parts located under corresponding ones of the first transfer gate electrodes 5 by the vertical transfer units 3 is sequentially moved in the horizontal direction by pre-sorting transfer, and is also moved in the vertical direction (i.e., a direction from the pixel region 10 toward the sorting transfer unit 7). In this case, as ΦH1 and ΦH2, pulses having different levels are applied. Thus, in a part of each of the first transfer gate electrodes 5 located obliquely relative to the vertical direction, an electric field is generated in a perpendicular direction to the first transfer gate electrode 5, and signal charge is moved in the horizontal direction and is also moved in the vertical direction. As ΦH1, a pulse having a low level voltage and a pulse having a high level voltage are alternately applied a plurality of times, and as ΦH2, pulses having opposite level voltages to those of the pulses of ΦH1 are applied. Thus, signal charge is moved to a part near the sorting transfer unit 7 and is stored in corresponding ones of the potential packet regions 17 provided respectively under the first transfer gate electrodes 5. Note that it is sufficient that the number of transfers to be performed in a single pre-sorting transfer is very small, as compared to the number of transfers in horizontal transfer which is to be performed later.

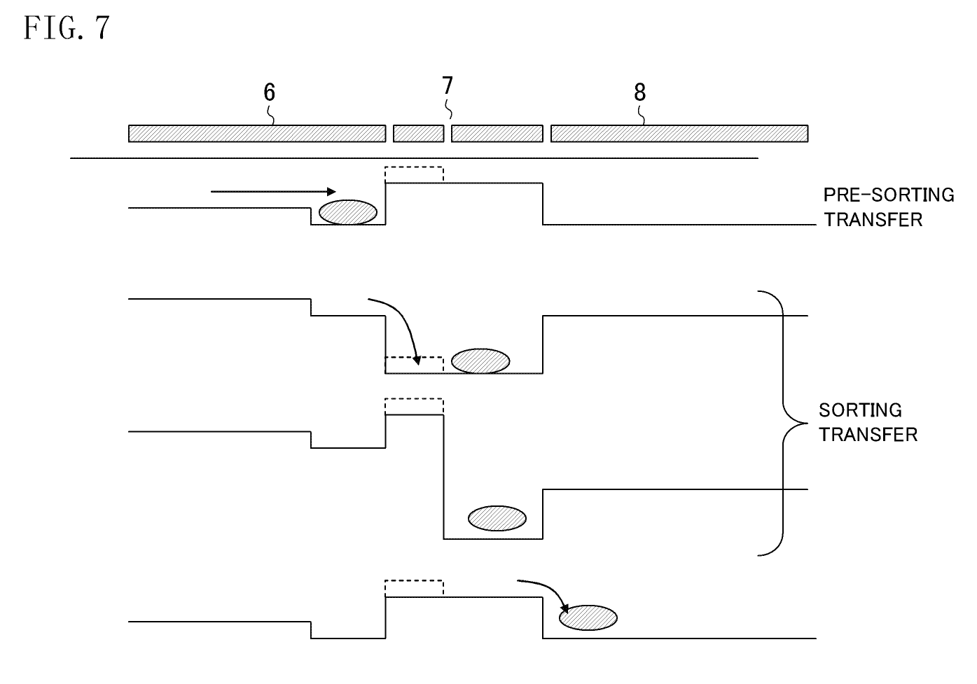

Subsequently, sorting transfer is performed to transfer a part of the signal charge from the single row, which has been output from the photo diodes 2 belonging to every other column is transferred from ones of potential packet regions 17 located under corresponding ones of the first transfer gate electrodes 5 to parts located under corresponding ones of the second transfer gate electrodes 9. FIG. 6 is a diagram showing pre-sorting transfer operation and sorting transfer operation when only the shift gate electrode SG is provided in the sorting transfer unit 7. FIG. 7 is a diagram showing pre-sorting transfer operation and sorting transfer operation when the first shift gate electrode SG1 and the second shift gate electrode SG2 are provided in the sorting transfer unit 7. FIG. 6 shows the potential at an end of a conductive band in a cross section taken along the line VI-VI of FIG. 4A, and FIG. 7 shows the potential at an end of a conductive band in a cross section taken along the line VII-VII of FIG. 4B.

As shown in FIG. 5A and FIG. 6, when only the shift gate electrode SG is provided in the sorting transfer unit 7, in sorting transfer, signal charge is transferred from the ones of the potential packet regions 17 located under ones of the first transfer gate electrodes 5 to which ΦH1 is applied to a part located under the shift gate electrode SG, and then, is transferred to parts located under ones of the second transfer gate electrodes 9 to which ΦH2 is applied. Also, as shown in FIG. 5B and FIG. 7, when the first shift gate electrode SG1 and the second shift gate electrode SG2 are provided in the sorting transfer unit 7, the potentials at the parts located under the first shift gate electrode SG1 and the second shift gate electrode SG2 are reduced by applying a high voltage to the first shift gate electrode SG1 and the second shift gate electrode SG2 so that signal charge is stored, and then, the potential at the part located under the first shift gate electrode SG1 is increased so that the signal charge is collected in the part located under the second shift gate electrode SG2. Thereafter, the signal charge is transferred to the parts located under ones of the second transfer gate electrodes 9 to which ΦH2 has been applied.

Next, horizontal transfer is performed to sequentially transfer signal charge remaining in the first horizontal transfer unit 6 to the first output unit 11, and sequentially transfer signal charge transferred to the second horizontal transfer unit 8 to the second output unit 13. Note that in horizontal transfer, the same pulses as those used as ΦH1 and ΦH2 in pre-sorting transfer are applied as ΦH1 and ΦH2 to the first transfer gate electrodes 5 and the second transfer gate electrodes 9.

The potential at the part located under the first shift gate electrode SG1 may be made to be higher than that at the part located under the second shift gate electrode SG2 in advance. Thus, charge can be easily transferred to the second transfer gate electrodes 9.

As described above, according to the driving method of this embodiment, pre-sorting transfer is performed before sorting transfer, and thus, the transfer efficiency during sorting transfer can be largely improved, as compared to conventional methods.

Note that similar advantages can be achieved by driving the solid-state imaging device of the first embodiment in the same manner as in the method for driving the solid-state imaging device according to this embodiment.

—Second Method for Driving Solid-State Imaging Device—

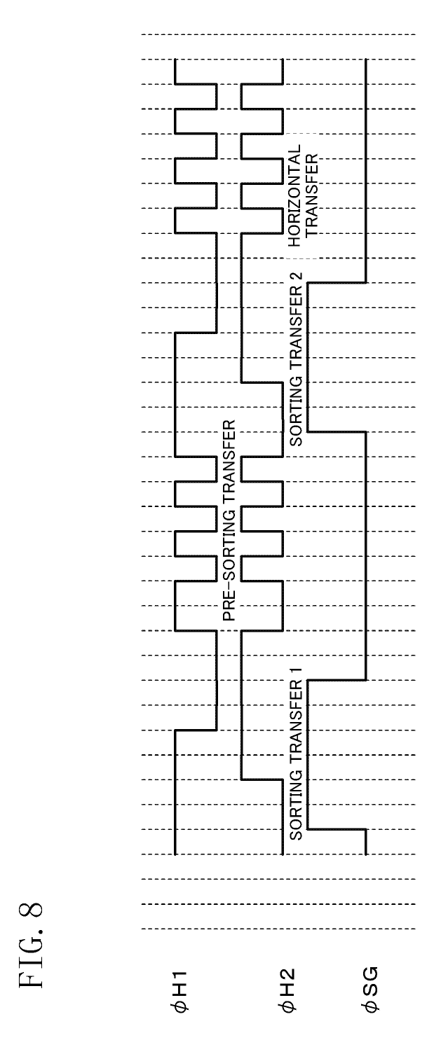

FIG. 8 is a timing diagram showing a second method for driving the solid-state imaging device according to this embodiment. In this driving method, after signal charge is transferred to parts located under corresponding ones of the first transfer gate electrodes 5 by the vertical transfer units 3, sorting transfer is performed first, pre-sorting transfer is performed next, and then, sorting transfer is performed again.

That is, in this method, a part or a most part of signal charge in the first horizontal transfer unit 6 is transferred to the second horizontal transfer unit 8 by first sorting transfer so that the amount of charge in the first horizontal transfer unit 6 is reduced, and then, pre-sorting transfer and sorting transfer are performed to transfer signal charge remaining in the first horizontal transfer unit 6 to the second horizontal transfer unit. When the amount of signal charge is large, charge might leak from the potential packet regions 17 during pre-sorting transfer. However, according to this driving method, even in such a case, a part of signal charge is transferred to the second horizontal transfer unit 8 by the first sorting transfer, and thus, charge can be prevented from leaking from the potential packet regions 17 during subsequent pre-sorting transfer. Therefore, signal charge can be completely transferred to the second horizontal transfer unit 8 by the second sorting transfer. In the second horizontal transfer unit 8, charge transferred by the second sorting transfer is mixed with charge transferred by the first sorting transfer, and then, the mixed charge is transferred in the horizontal direction toward the second output unit 13.

Note that in the example of FIG. 8, pre-sorting transfer is not performed before the first sorting transfer. However, pre-sorting transfer and subsequent sorting transfer as a set may be repeated several times.

Also, even when three or more horizontal transfer units are provided, the above-described driving method is effective.

### THIRD EMBODIMENT

In the second embodiment, the example in which horizontal transfer is performed by a two phase driving method has been described. In contrast, in a solid-state imaging device according to this embodiment, horizontal transfer can be performed by a three or more phase driving method. A driving method in which horizontal transfer is performed by a four phase driving method will be hereinafter described as a third embodiment of the present disclosure.

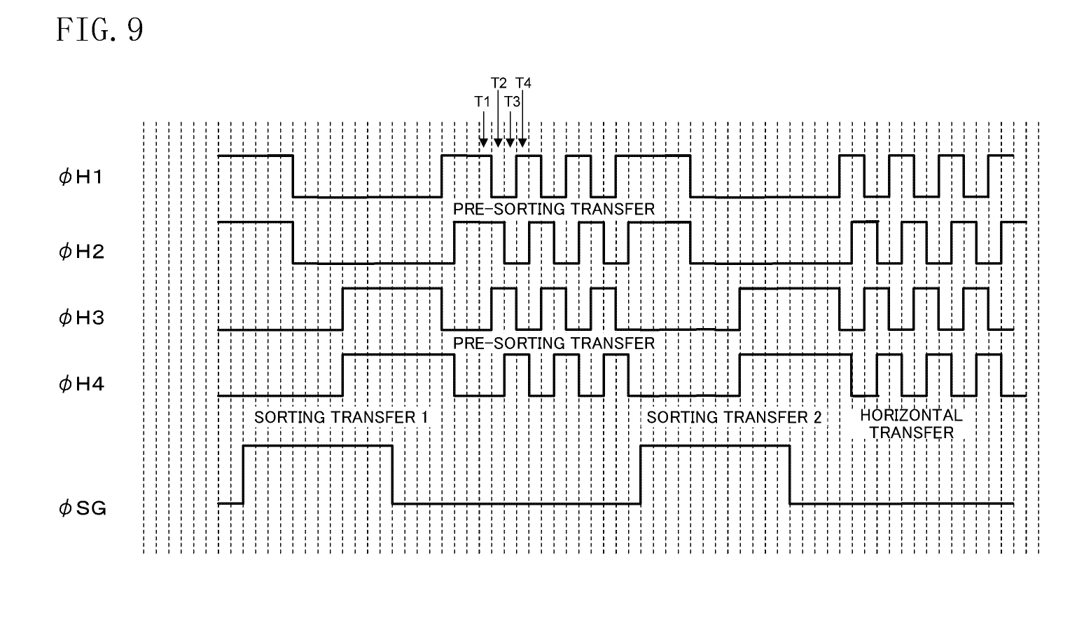

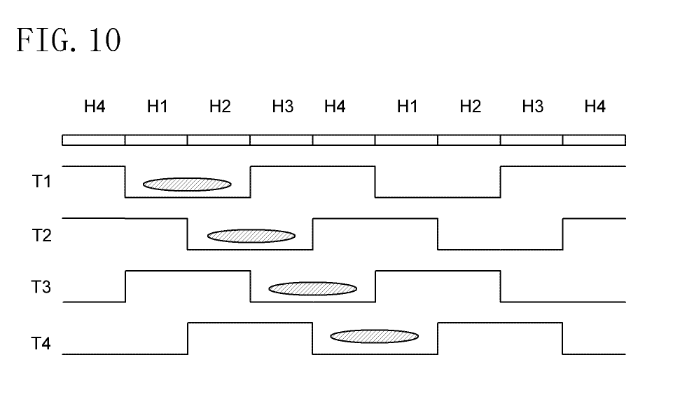

FIG. 9 is a timing diagram showing an example of a method for driving the solid-state imaging device according to the third embodiment. FIG. 10 is a diagram schematically illustrating how signal charge is moved during pre-sorting transfer in the driving method of this embodiment. Similar to FIG. 8, FIG. 10 shows an example in which sorting transfer is performed several times (e.g., twice) before horizontal transfer.

In this driving method, first, sorting transfer is performed to transfer a part of signal charge output from photo diodes in predetermined columns (for example, even columns or odd columns) from the first horizontal transfer unit 6 to the second horizontal transfer unit 8 via the sorting transfer unit 7. In this case, control voltages ΦH1, ΦH2, ΦH3, and ΦH4 are applied to (4n-3)th, (4n-2)th, (4n-1)th, and 4nth ones of the first transfer gate electrodes 5 and the second transfer gate electrodes 9 from an end thereof, where n is an integer equal to or greater than one.

Next, pre-sorting transfer is performed to collect a part of signal charge in the predetermined columns which remains in the first horizontal transfer unit 6 in the potential packet regions 17. In this case, during the time from a time T1 to a time T4 shown in FIGS. 9 and 10, signal charge is subsequently moved in the horizontal direction and is also moved in the vertical direction to be stored in the potential packet regions 17.

Thereafter, sorting transfer is performed again to transfer a remaining part of signal charge stored in the potential packet regions 17 to the second horizontal transfer unit 8.

Next, the signal charge initially transferred is mixed with the signal charge transferred by the second sorting transfer, and the signal charge remaining in the first horizontal transfer unit 6 and the signal charge transferred to the second horizontal transfer unit 8 are transferred in the horizontal direction.

By driving the solid-state imaging device in the above-described manner, even when the amount of signal charge is large, charge can be prevented from leaking from the potential packet region 17 and spreading.

Note that when horizontal transfer is performed by a two phase driving method, a storage region and a barrier region are provided under each of the first transfer gate electrodes 5 and the second transfer gate electrodes 9. However, using a three or more phase driving method, horizontal transfer can be preformed without the storage region and the barrier regions being provided.

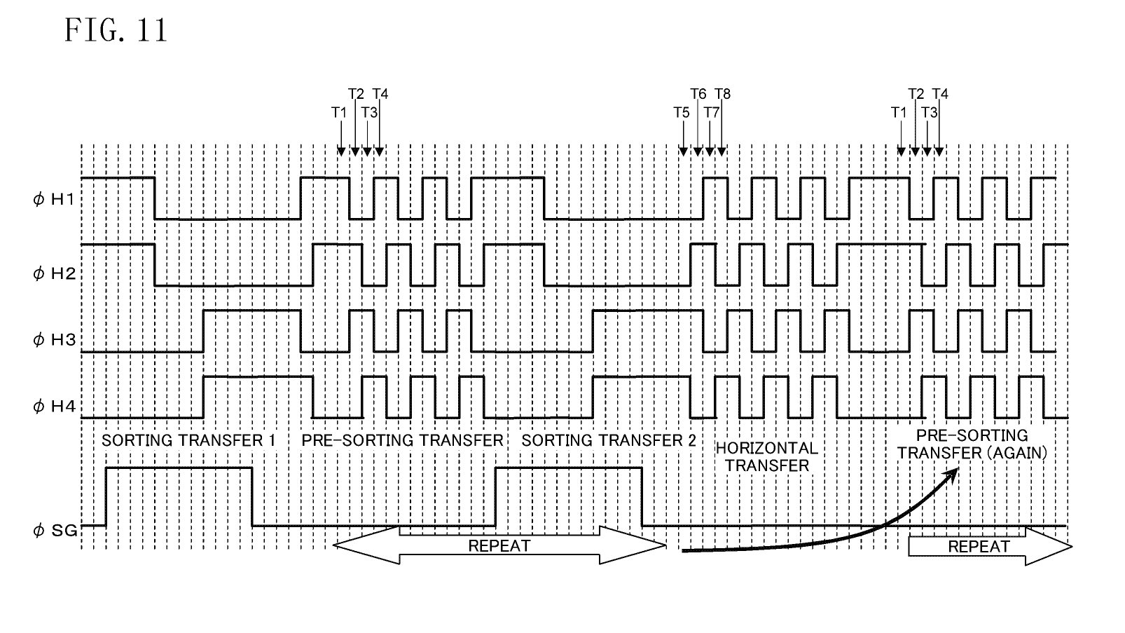

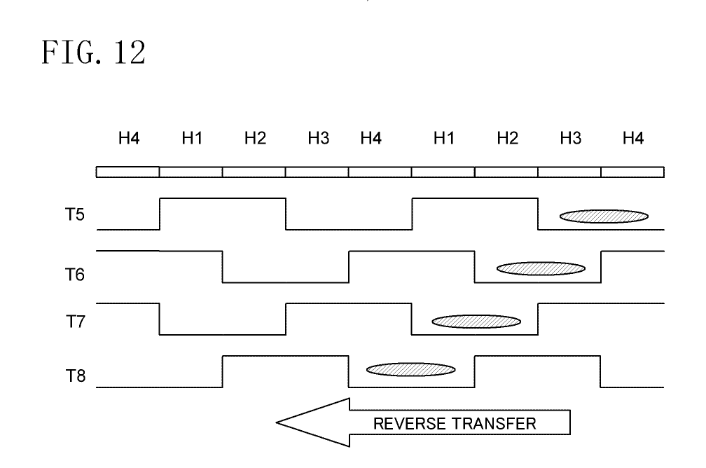

As shown in FIGS. 11 and 12, when horizontal transfer is performed by a four phase driving method, signal charge can be transferred in a reverse direction. FIG. 11 is a timing diagram showing the method for driving the solid-state imaging device according to this embodiment, when horizontal reverse transfer is performed. FIG. 12 is a diagram schematically illustrating how signal charge is moved during horizontal reverse transfer in the driving method of FIG. 11.

In the example shown in FIGS. 11 and 12, sorting transfer, pre-sorting transfer, and second sorting transfer are performed in this order, and then, horizontal reverse transfer is performed. In this case, as indicated by times T5-T8 in FIG. 12, in contrary to pre-sorting transfer, rising edges of the control signals are delayed in a direction from ΦH4 to ΦH1. Thereafter, pre-sorting transfer is performed again.

In the solid-state imaging devices of the first and second embodiments, when pre-sorting transfer is performed, signal charge is transferred over a distance corresponding to the number of transfer stages in the horizontal direction. Thus, if pre-sorting transfer is repeated many times in the driving method of FIG. 9, signal charge has been already transferred to a part near the output at the time when sorting transfer is completed and horizontal transfer is performed. When the driving method of FIG. 11 is used, signal charge which has been moved in the horizontal direction by pre-sorting transfer can be moved back in the reverse direction by horizontal reverse transfer. Thus, even when pre-sorting transfer is repeated many times, no problem arises in transfer of signal charge. Note that since the potential packet regions 17 whose potential is low are provided in the first horizontal transfer unit 6 of the solid-state imaging device, signal charge does not move back to a side of the pixel region 10, even when horizontal reverse transfer is performed.

An example in which horizontal reverse transfer is performed when horizontal transfer is performed by a four phase driving method has been described above. However, as long as three or more phase driving method is used, horizontal reverse transfer can be performed. To perform horizontal reverse transfer, it is necessary that a storage region and a barrier region are not formed under the first transfer gate electrodes 5 and the second transfer gate electrodes 9 and that the potential is substantially uniform in the horizontal direction in parts respectively located immediately under the first transfer gate electrodes 5 and the second transfer gate electrodes 9.

Each of the driving method of the second embodiment and the driving method of this embodiment may be executed by a control circuit in the solid-state imaging device, and a computer controlled by a program in which the above-described driving methods are described, etc. Also, a program configured to execute the above-described driving methods may be stored in a memory provided in an imaging device such as camera, etc., and also may be stored in a removable recording medium such as a CD-ROM, and a memory card, etc. A program configured to execute the above-described driving methods can be provided via a transmission medium such as Internet, etc.

—Variations of Driving Method—

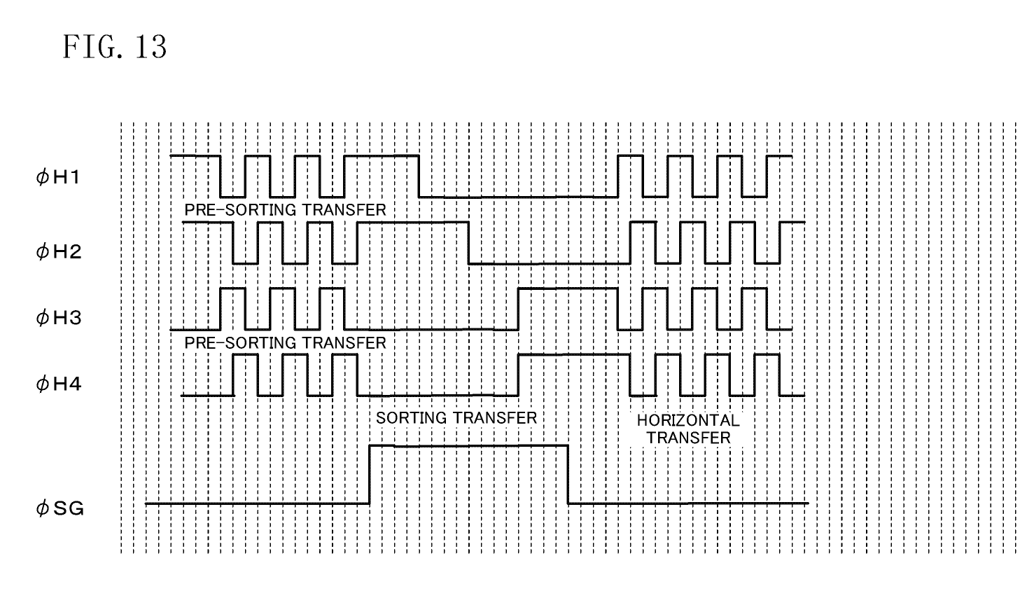

FIG. 13 is a timing diagram showing a variation of the method for driving the solid-state imaging device according to the third embodiment. As shown in FIG. 13, when horizontal transfer is performed by a four phase driving method, signal charge stored in parts under ones of the first transfer gate electrodes 5 to which ΦH1 and ΦH2 are applied during sorting transfer after pre-sorting transfer may be collected in parts located under ones of the first transfer gate electrodes to which ΦH1 is applied, and then, ΦH2 may be made to be at a low level to transfer the signal charge to the shift gate electrode SG. According to this method, the Coulombic repulsion force can be utilized by increasing the charge density, so that the efficiency of sorting transfer can be improved.

### FOURTH EMBODIMENT

FIG. 14 is a view schematically illustrating a planar configuration of a solid-state imaging device according to a fourth embodiment of the present disclosure.

As shown in FIG. 14, the solid-state imaging device of this embodiment is configured so that the second transfer gate electrodes 9 are arranged obliquely relative to the vertical direction as well as the first transfer gate electrodes 5 are in the solid-state imaging device of the first embodiment. For example, the direction in which the first transfer gate electrodes 5 are arranged and the direction in which the second transfer gate electrodes 9 are arranged are parallel to each other.

As described above, the first transfer gate electrodes 5 and the second transfer gate electrodes 9 are formed so that the shape and arrangement of the second transfer gate electrodes 9 are similar to the shape and arrangement of the first transfer gate electrodes 5. Thus, the first horizontal transfer unit 6 and the second horizontal transfer unit 8 can have uniform operating characteristics. Also, the first horizontal transfer unit 6 and the second horizontal transfer unit 8 can be made to have further uniform characteristics by providing the first output unit 11 and the second output unit 13 having the same shape.

Specifically, in each of the output units, a transistor is formed at a part near a floating diffusion (FD), charge is converted into voltage in the FD, and then, the output impedance is reduced (not shown). According to this embodiment, similar regions can be reliably provided in parts near first output unit 11 and the second output unit 13. Thus, in the process of forming transistors serving as outputs, the first output unit 11 and the second output unit 13 can be formed to have the same layout. Therefore, differences in characteristics caused by differences between the output units can be advantageously reduced or eliminated.

Also, the freedom of design of the horizontal transfer unit can be improved, so that the performance of a FD amplifier can be improved.

Note that when three or more horizontal transfer units are provided in parallel, the horizontal transfer units can be made to have uniform operating characteristics by providing transfer gate electrodes having the same shape in all of the horizontal transfer units.

### FIFTH EMBODIMENT

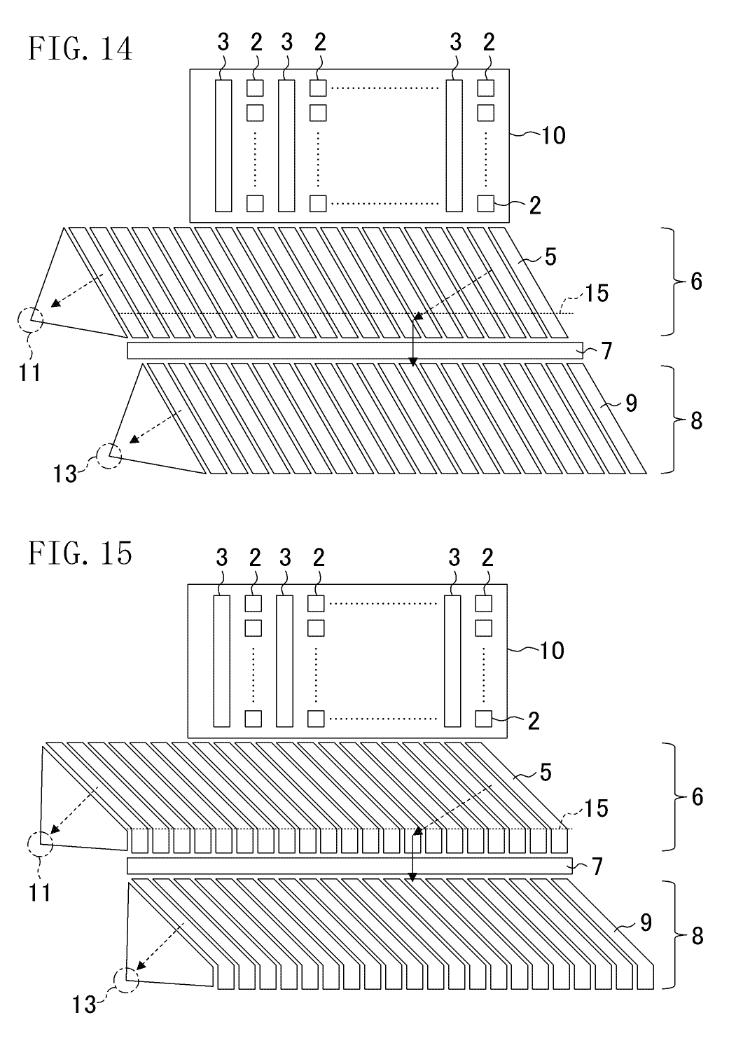

FIG. 15 is a view schematically illustrating a planar configuration of a solid-state imaging device according to a fifth embodiment of the present disclosure.

As shown in FIG. 15, the solid-state imaging device of this embodiment is configured so that the second transfer gate electrodes 9 are arranged obliquely relative to the vertical direction at an angle of about 45 degrees as well as the first transfer gate electrodes 5 are in the solid-state imaging device of FIG. 3. Note that the internal potential steps 15 and the potential packet regions 17 do not have to be provided in the second horizontal transfer unit 8.

When potential packet regions are provided in the second horizontal transfer unit, the Coulombic repulsion force can be utilized to effectively transfer signal charge. Thus, it is preferable to provide potential packet regions in the second horizontal transfer unit.

In the solid-state imaging device of this embodiment, the first horizontal transfer unit 6 and the second horizontal transfer unit 8 can be formed to have uniform operating characteristics.

### SIXTH EMBODIMENT

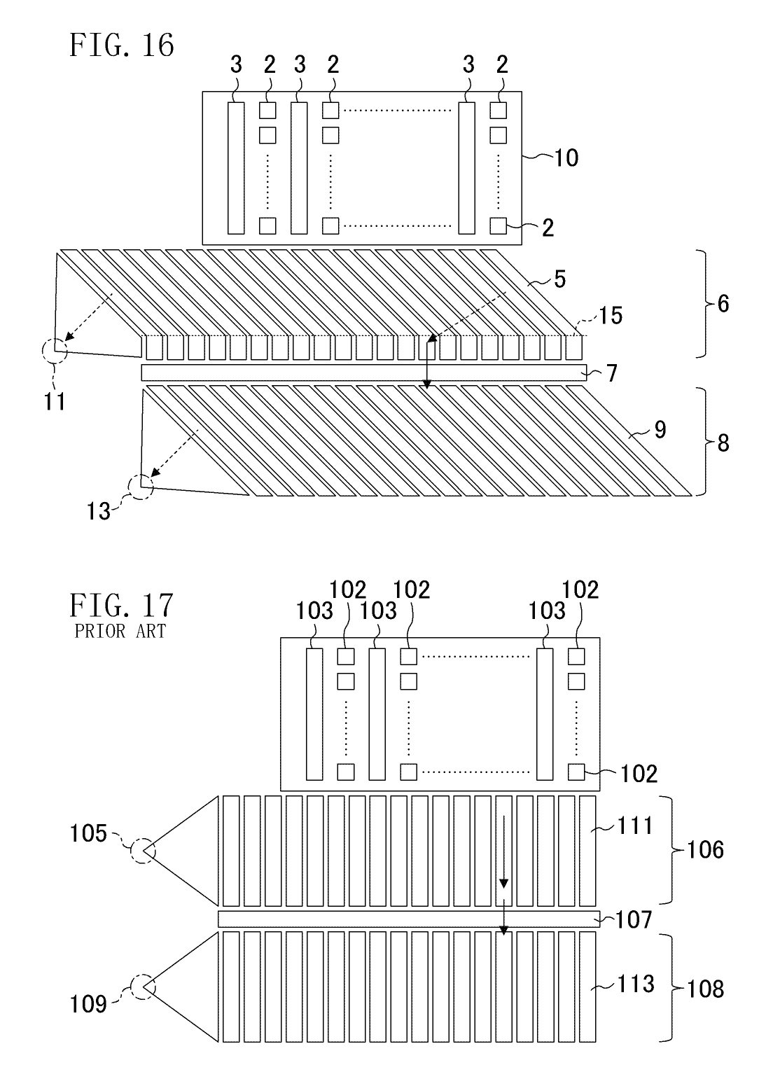

FIG. 16 is a view schematically illustrating a planar configuration of a solid-state imaging device according to a sixth embodiment of the present disclosure. As shown in FIG. 16, the solid-state imaging device of this embodiment is configured so that the second transfer gate electrodes 9 are arranged obliquely relative to the vertical direction at an angle of about 45 degrees, and an end portion of each of the second transfer gate electrodes 9 located closer to the sorting transfer unit 7 is not bent.

As described above, even when the layout of the second transfer gate electrodes 9 is relatively freely designed, as compared to the first transfer gate electrodes 5, similar advantages to those of the present disclosure can be achieved.

Note that the configurations of the above-described embodiments may be appropriately combined without departing from the spirit or essential character of the present disclosure.

It will be appreciated by those of ordinary skill in the art that the disclosure is not limited to any one of the foregoing embodiments and can be embodied in other specific forms without departing from the spirit or essential character thereof.

A solid-state imaging device according to the present disclosure and a method for driving the solid-state imaging device may be applied to various imaging devices such as digital cameras, and video cameras, etc.

What is claimed is:

1. A solid-state imaging device, comprising:
a plurality of light receiving units arranged in a two-dimensional array;
a plurality of vertical transfer units each of which is configured to transfer charge read from an associated one of the plurality of the light receiving units in a vertical direction;
a plurality of horizontal transfer units each of which is configured to transfer the charge transferred by the vertical transfer units in a horizontal direction and includes a plurality of transfer gate electrodes arranged in parallel to one another on a substrate, the plurality of horizontal transfer units being arranged in the vertical direction;
a sorting transfer unit which includes at least one shift gate electrode being provided on the substrate and extending in the horizontal direction, is provided between the plurality of the horizontal transfer units, and is configured to transfer charge between the plurality of the horizontal transfer units; and
an output unit configured to detect the charge transferred by the plurality of horizontal transfer units,
wherein
in a first horizontal transfer unit which is one of the plurality of the horizontal transfer units other than one of the horizontal transfer units located farthest from the vertical transfer units, the plurality of transfer gate electrodes extend from a side of the first horizontal transfer unit located closer to the vertical transfer units toward the sorting transfer unit located adjacent to the first horizontal transfer unit in the vertical direction, and at least a part of each of the plurality of transfer gate electrodes located closer to the vertical transfer units obliquely extends so that a horizontal distance from the output unit increases as it extends toward the sorting transfer unit located adjacent to the first horizontal transfer unit in the vertical direction.

2. The device of claim 1, wherein
the first horizontal transfer unit is one of the plurality of horizontal transfer units located closest to the vertical transfer unit.

3. The device of claim 1, wherein
in the first horizontal transfer unit, an entire part of each of the plurality of transfer gate electrodes obliquely extends so that the horizontal distance from the output unit increases as it extends toward the sorting transfer unit.

4. The device of claim 1, wherein
in the first horizontal transfer unit, potential packet regions are respectively formed immediately under parts of the plurality of transfer gate electrodes facing the sorting transfer unit located adjacent to the first horizontal transfer unit in the vertical direction, and each of the potential packet regions has a lower potential than potentials of regions located immediately under other parts of the transfer gate electrodes.

5. The device of claim 4, wherein
a concentration of an n-type impurity contained in each of parts of the substrate respectively located in the potential packet regions is higher than a concentration of an n-type impurity contained in each of parts of the substrate which are respectively located immediately under the plurality of transfer gate electrodes and are other than the potential packet regions.

6. The device of claim 4, wherein
a storage region configured to store charge and a barrier region whose potential is higher than a potential of the storage portion are formed immediately under each of the plurality of transfer gate electrodes, and comparing the regions provided immediately under the transfer gate electrode, a width of the storage region is wider in the potential packet region than those in the other regions under the transfer gate electrode.

7. The device of claim 1, wherein
in the first horizontal transfer unit, each of the plurality of transfer gate electrodes includes a bent portion which is bent so that an end portion of the transfer gate electrode located closer to the sorting transfer unit located adjacent to the first horizontal transfer unit in the vertical direction extends in the vertical direction.

8. The device of claim 1, wherein
in the first horizontal transfer unit, each of the plurality of transfer gate electrodes includes a portion which makes an acute angle with the vertical direction, when viewed in a plan view, and obliquely extends toward the sorting transfer unit located adjacent to the first horizontal transfer unit in the vertical direction.

9. The device of claim 1, wherein
a shape and an arrangement of the plurality of transfer gate electrodes in each of the plurality of the horizontal transfer units are substantially the same as those of the plurality of transfer gate electrodes in the first horizontal transfer units.

10. A method for driving a solid-state imaging device, the solid-state imaging device including a plurality of light receiving units arranged in a two-dimensional array, a plurality of vertical transfer units, a plurality of horizontal transfer units each of which includes a plurality of transfer gate electrodes arranged in parallel to one another on a substrate, the plurality of horizontal transfer units being arranged in the vertical direction, a sorting transfer unit which includes at least one shift gate electrode being provided on the substrate and extending in the horizontal direction, and is provided between the plurality of the horizontal transfer units, and an output unit provided for each of the plurality of the horizontal transfer units, the solid-state imaging device being configured so that in a first horizontal transfer unit which is one of the plurality of the horizontal transfer units located closest to the vertical transfer unit, the plurality of transfer gate electrodes extend from the vertical transfer units toward the sorting transfer unit located adjacent to the first horizontal transfer unit, and at least a part of each of the plurality of transfer gate electrodes located closer to the vertical transfer units obliquely extends so that a horizontal distance from the output unit increases as it extends toward the sorting transfer unit, the method comprising the steps of:
(a) transferring charge read from the plurality of light receiving units in the vertical direction toward the first horizontal transfer unit by the vertical transfer units;
(b) moving the charge transferred in the step (a) in the horizontal direction and moving the charge in the vertical direction;
(c) applying a control voltage to the at least one shift gate electrode to sort a part of the charge transferred in the step (a) and transferring the sorted part from the first horizontal transfer unit to a second transfer unit which is one of the plurality of horizontal transfer units located adjacent to the first horizontal transfer unit via the sorting transfer unit; and
(d) transferring, after the steps (b) and (c), charge in the first horizontal transfer unit and the second horizontal transfer unit in the horizontal direction toward the output unit.

11. The method of claim 10, wherein
in the first horizontal transfer unit, potential packet regions are respectively formed immediately under parts of the plurality of transfer gate electrodes facing the sorting transfer unit, and each of the potential packet regions has a lower potential than potentials of regions located immediately under other parts of the transfer gate electrodes, and
in the step (b), charge is stored in the potential packet regions.

12. The method of claim 10, further comprising the step of:
(e) applying a control voltage to the at least one shift gate electrode to sort a part of the charge transferred in the step (a) and transferring the sorted part from the first horizontal transfer unit to the second transfer unit via the sorting transfer unit, after the step (a) and before the step (b).

13. The method of claim 12, wherein
the step (b) and the step (c) are repeated as a set several times.

14. The method of claim 10, further comprising the step of:
(f) transferring charge in the first horizontal transfer unit and the second horizontal transfer unit in the reverse horizontal direction toward the output unit.
